(19) United States
(12) Patent Application Publication
(10) Pub. No.: US 2009/0166163 A1
(43) Pub. Date: Jul. 2, 2009

(54) Push switch

(75) Inventors: Hideo Moro, Tokyo (JP); Yosuke Kawamata, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/783,257

(22) Filed: Apr. 6, 2007

(30) Foreign Application Priority Data
Apr. 7, 2006 (JP) 2006-105833

(51) Int. Cl. H01H 9/00

(52) U.S. Cl. 200/314

(57) ABSTRACT

A push switch includes a base board disposed in a bottom wall of a switch housing, a switch knob which projects or retracts from the switch housing so as to separate or have contact relative to the base board, a partition for zoning an inside portion of the switching housing into a first switching room and a second switching room, a first light source disposed on the base board and positioned in the first switching room, and a second light source disposed on the base board and positioned in the second switching room, the switch knob including a first translucent path for guiding light from the first light source to a surface, a second translucent path for guiding light from the second light source to a surface, and a non-translucent wall disposed between the first and second translucent paths.

### CROSS-REFERENCE TO THE RELATED APPLICATION

The present application is based on and claims priority from Japanese Patent Application No.2006-105833 filed on Apr. 7, 2006, the disclosure of which is hereby incorporated by reference herein in its entirety.

### BACKGROUND

The present invention relates to a push switch in which different parts on a surface of a switch knob are illuminated by a plurality of light sources provided in a base board.

A switch keycap including a plurality of display parts through which light from a plurality of light sources disposed behind the display parts penetrates, and a partition which prevents light interference from the plurality of light sources (for example, refer to JP3300434B), is known.

In this switch keycap, display characters emit light by means of light from an illumination ball, which has passed through a hole, so as to display the display characters, and an indicator display part emits light by means of light from an indicator LED, which has passed through a storage room zoned by the partition from the hole, so as to display the indicator display part.

In the above switch keycap, however, the illumination areas are limited by the partition, causing a problem in that the displayable area is narrowed.

Moreover, the light from the illumination ball enters into the storage room, so that the light from the illumination ball may interfere with the light from the indicator LED.

Accordingly, there is a need for a push switch which can expand a displayable area and also can reliably prevent light interference among a plurality of light sources.

### SUMMARY

One aspect of the present invention relates to a push switch including a base board disposed in a bottom wall of a switch housing, a switch knob which projects or retracts from the switch housing so as to separate or have contact relative to the base board, a partition for zoning an inside portion of the switching housing into a first switching room and a second switching room, a first light source disposed on the base board and positioned in the first switching room, and a second light source disposed on the base board and positioned in the second switching room, the switch knob including a first translucent path for guiding light from the first light source to a surface, a second translucent path for guiding light from the second light source to a surface, and a non-translucent wall disposed between the first and second translucent paths, wherein the first switching room includes a light shielding wall having a translucent opening opposed to the first translucent path, for zooming an area between the first light source and the switch knob, and the non-translucent wall slides in the first switching room.

### BRIEF DESCRIPTION OF THE DRAWINGS

FIG. 1 is a front view illustrating a vehicle-mounted device including a push switch according to the present invention.

FIG. 2 is an A-A cross-sectional view in FIG. 1.

FIG. 3 is a B-B cross-sectional view in FIG. 2.

FIG. 4 is a perspective view showing a knob body.

FIG. 5 is a cross-sectional view illustrating a state in which the push switch according to the present invention is pressed.

### DESCRIPTION OF THE PREFERRED EMBODIMENT

Hereinafter, an embodiment of a push switch according to the present invention will be explained with reference to the drawings.

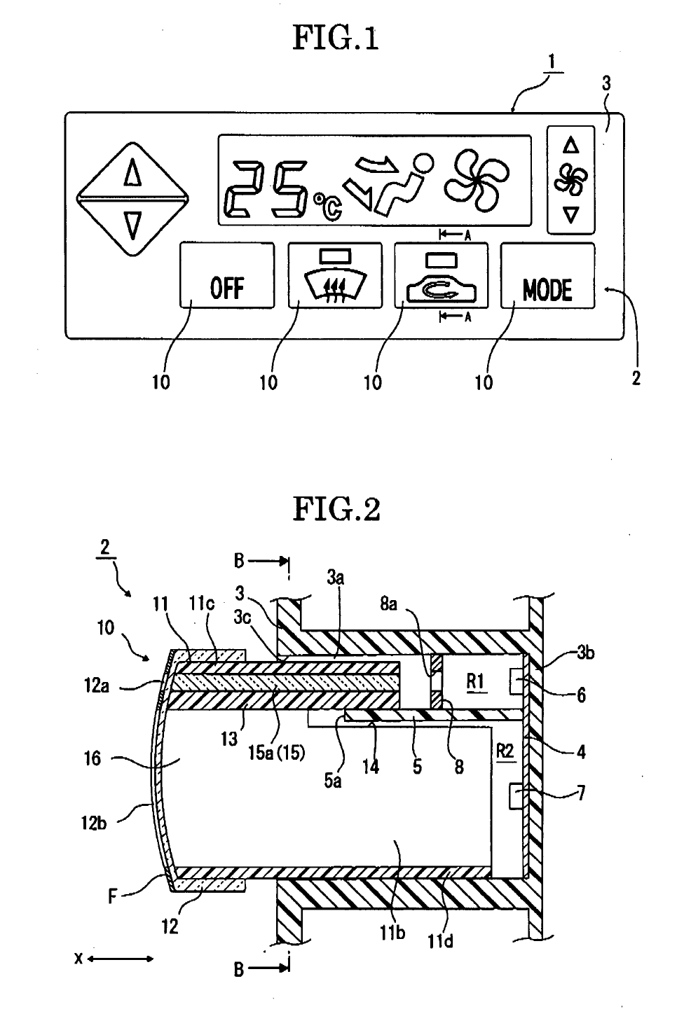

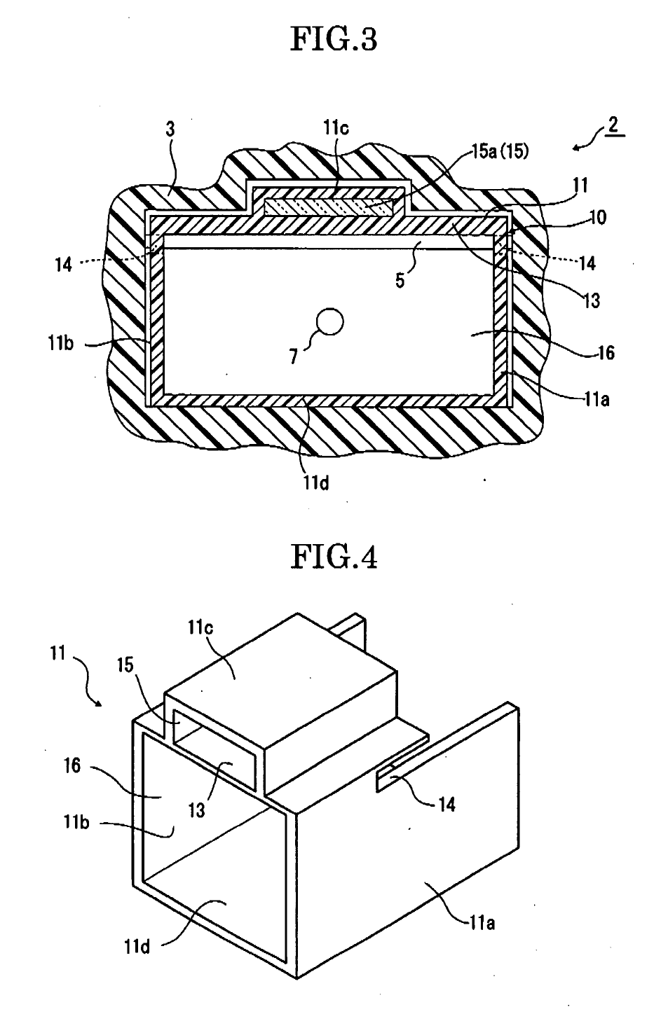

Referring to FIG. 1, a vehicle-mounted device 1 such as an air-conditioner or an audio system disposed in an interior of a vehicle such as an automobile includes a push switch 2 (hereinafter, referred to as a switch) for operating the vehicle-mounted device 1.

The switch 2 includes a switch housing 3 disposed in the vehicle interior side (front side) of the vehicle-mounted device 1 and a switch knob 10 capable of projecting or retracting from the switch housing 3.

Referring to FIG. 2, the switch housing 3 includes a concave part 3a to which the switch knob 10 can be inserted. The concave part 3a opens toward the vehicle interior side (front side). The concave part 3a includes a base board 4 provided in a bottom wall 3b. In addition, a plurality of concave parts 3a is formed corresponding to the number of switch knobs 10.

The base board 4 includes a partition 5, a first light source 6 and a second light source 7. The partition 5 zones the concave part 3a of the switch housing 3 into a first switching room R1 and a second switching room R2. The first light source 6 is disposed in the first switching room R1 and the second light source 7 is disposed in the second switching room R2. The base board 4 also includes a fixed contact (not shown) and a control part (not shown). The control part controls the flashing of the first and second light sources 6, 7 in accordance with the contact state between the fixed contact and an after-mentioned movable contact.

The partition 5 projects from the base board 4 toward an opening part 3c of the concave part 3a, such that a leading end part 5a of the partition 5 does not project from the opening part 3c of the concave part 3a. In addition, the partition 5a is formed by a non-translucent member which does not transmit light.

The first light source 6 and the second light source 7 are LEDs, which illuminate the direction of the opening parts 3c of the concave part 3a, respectively. In this case, since the first light source 6 is located in the first switching room R1 and the second light source 7 is located in the second switching room R2, the partition 5 is located between the first light source 6 and the second light source 7. The light from the first light source 6 does not therefore interfere with the light from the second light source 7.

The first switching room R1 includes a light shielding wall 8 for zoning the area between the first light source 6 and the switch knob 10.

This light shielding wall 8 is disposed between the side plane of the switch housing 3 and the partition 5. The light shielding wall 8 includes a translucent opening 8a formed in about the center thereof. The translucent opening 8a is opposed to an after-mentioned first translucent path 15.

The translucent opening 8a penetrates the light shielding wall 8. The light from the first light source 6 passes through the translucent opening 8a.

On the other hand, the switch knob 10 is retained in the concave part 3a of the switch housing 3 by a retainer (not shown), so as to separate or have contact relative to the base board 4.

Referring to FIG. 4, the switch knob 10 includes a knob body 11 of a hollow casing body, a cap part 12 and a movable contact (not shown). The knob body 11 is opened at both ends. The cap part 12 is fitted to one end of the knob body 11. The movable contact is provided in the other end of the knob body 11.

The knob body 11 is formed by a non-translucent member which does not transmit light. The inside portion of the knob body 11 is zoned by a non-translucent wall 13. The knob body 11 includes slits 14 through which the partition 5 can be inserted. The slits 14 are formed in both side walls 11a, 11b of the knob body 11, along the projecting or retracting direction of the knob body 11.

In this case, the projecting or retracting direction is a direction in which the knob body 11 separates or has contact relative to the base board 4 as shown by the arrow X in FIG. 2.

The non-translucent wall 13 extends along the projecting or retracting direction of the knob body 11 and is located closer to an upper wall 11c than each of the slits 14. If the knob body 11 separates or has contact relative to the base board 4, the non-translucent wall 13 slides in the first switching room R1.

In this case, each of the non-translucent wall 13 and the upper wall 11c of the knob body 11 has a length shorter than that of the lower wall 11d of the knob body 11. Therefore, the non-translucent wall 13 and the upper wall 11c do not interfere with the light-shielding wall 8, when the knob body 11 separates or has contact with respect to the base board 4.

The knob body 11 includes in its inside a first translucent path 15 and a second translucent path 16 formed by the non-translucent wall 13. The first translucent path 15 leads the light from the first light source 6 to an after-mentioned first display part 12a. The second translucent path 16 leads the light from the second light source 7 to an after-mentioned second display part 12b.

The first translucent path 15 includes a light guide plate 15a inside thereof. The light guide plate 15a is sandwiched between the upper wall 11c and the non-translucent wall 13 of the knob body 11. In addition, the light guide body 15a guides the light from the first light source 6 to the first display part 12a such that the light from the first light source 6 that has entered into the first translucent path 15 does not diffuse. The light guide body 15a is formed by a glass board or an acrylic board, for example.

The second translucent path 16 has a hollow body. The light from the second light source 7 directly enters into the second display part 12b.

The cap part 12 is fitted to one end of the knob body 11. The cap part 12 includes the first display part 12a having translucency and the second display part 12b having translucency. The first display part 12a is formed in a position opposed to the first light translucent path 15. The second display part 12b is formed in a position opposed to the second translucent path 16.

In this case, the first display part 12a is an indicator part. The second display part 12b is a character part.

Moreover, the first and second display parts 12a, 12b are formed by covering the surface of the cap part 12 made of a translucent member by means of a non-translucent film F, and by cutting a predetermined portion of the non-translucent film F.

Next, the operations of the switch 2 according to the present invention will be explained.

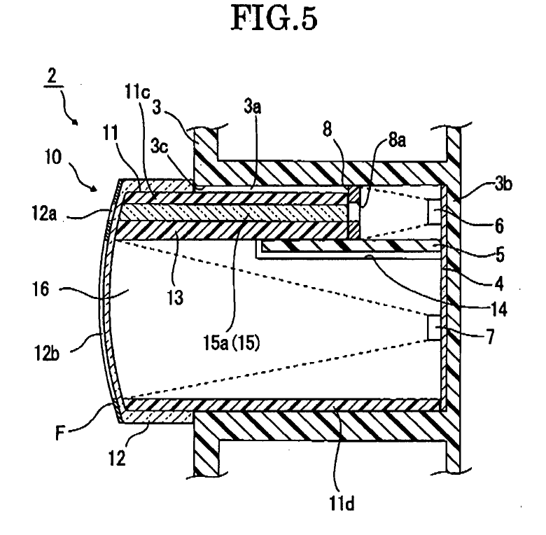

Referring to FIG. 5, when operating the vehicle-mounted device 1, a predetermined switch knob 10 of the switch 2 is pressed.

If the knob body 11 of the pressed switch 10 slides in the concave part 3a toward the base board 4, the lower wall 11d has contact with the base board 4 while the upper wall 11c and the non-translucent wall 13 have contact with the light-shielding wall 8.

In this case, since the partition 5 provided in the base board 4 is inserted into the slits 14 formed in the knob body 11, the non-translucent wall 13 disposed closer to the upper wall 11c side than the slits 14 slides in the first switching room R1 along the partition 5.

If the base board 4 has contact with the switch knob 10, a fixed contact (not shown) provided in the base board 4 has contact with a movable contact (not shown) provided in the knob body 11 of the pressed switch knob 10, and thus predetermined contact signals are input to a control part (not shown).

The control portion to which the contact signals are input illuminates the first and second light sources 6, 7 corresponding to the pressed switching knob 10.

The light illuminated from the first light source 6 is incident on the light shielding wall 8, passing through the light shielding wall 8 via the translucent opening 8a formed in the light shielding wall 8.

In this case, since the translucent opening 8a is opposed to the first translucent path 15, the first translucent path 15 comes close to the translucent opening 8a if the switching knob 10 is pressed. Accordingly, the light which has passed through the translucent opening 8a enters into the first translucent path 15 without diffusing, and the light passes through the light guide body 15a in the first translucent path 15 so as to illuminate the first display part 12a.

Herewith, it becomes possible to prevent the light leakage between the partition 5 and the non-translucent wall 13 which slides in the first switching room R1 along the partition 5, and also to prevent the light interference between the first and second light sources 6, 7.

On the other hand, the light illuminated from the second light source 7 passes through the second translucent path 16 while diffusing so as to directly illuminate the second display part 12b.

In this case, the partition 5 is inserted into the slits 14, while the non-translucent wall 13 slides in the first switching room R1, so that the interference between the partition 5 and the non-translucent wall 13 is avoided.

The thickness of the non-translucent wall 13 can be therefore controlled, and the light-emitting display area of the second translucent path 16 positioned between the non-translucent wall 13 and the lower wall 11d of the knob body 11 can be expanded. Accordingly, the display area of the second display part 12b can be increased.

Moreover, when the switching knob 10 is pressed, the upper wall 11c and the non-translucent wall 13 have contact with the light shielding wall 8, so that the switching knob 10 can be pressed in a stable state while preventing the movement of the knob body 11.

In the above embodiment, the light guide body 15a is disposed in the first translucent path 15, but it is not always necessary to dispose the light guide body 15a as such. The light guide body 15a may be disposed in the second translucent path 16.

Moreover, by coloring the light guide body 15a, the first and second display parts 12a, 12b can emit arbitrary colored light.

The push button according to the embodiment of the present invention has the following effects.

According to one embodiment of the present invention, the light leakage of the first light source 6 from the gap between the partition 5 and the non-translucent wall 13 can be prevented while reliably preventing the light interference between the first and second light sources 6, 7.

Moreover, since the non-translucent wall 13 slides in the first switching room R1, the thickness of the non-translucent wall 13 can be controlled; thus, the light-emitting display area of the second translucent path 16 can be expanded.

Although the present invention has been described in terms of an exemplary embodiment, it is not limited thereto. It should be appreciated that variations may be made in the embodiments described by persons skilled in the art without departing from the scope of the present invention as defined by the following claims. In addition, the number, position, shape, or the like of the components are not limited to the above embodiments, and can be changed to the number, position, shape or the like of components preferable for conducting the present invention. Moreover, no element or component in the present disclosure is intended to be dedicated to the public regardless of whether the element or component is explicitly recited in the following claims.

What is claimed is:

1. A push switch, comprising:
a base board disposed in a bottom wall of a switch housing;
a switch knob which projects or retracts from the switch housing so as to separate or have contact relative to the base board;
a partition for zoning an inside portion of the switching housing into a first switching room and a second switching room;
a first light source disposed on the base board and positioned in the first switching room; and
a second light source disposed on the base board and positioned in the second switching room,
the switch knob, including:
a first translucent path for guiding light from the first light source to a surface;
a second translucent path for guiding light from the second light source to a surface; and
a non-translucent wall disposed between the first and second translucent paths, wherein
the first switching room includes a light shielding wall having a translucent opening opposed to the first translucent path, for zooming an area between the first light source and the switch knob, and
the non-translucent wall slides in the first switching room.
